(19) United States
(12) Patent Application Publication
(10) Pub. No.: US 2026/0219923 A1
(43) Pub. Date: Jul. 30, 2026

(54) SYSTEMS AND METHODS FOR DYNAMIC ACCESS RESTRICTIONS FOR BATCH PROCESSES

(71) Applicant: Wells Fargo Bank, N.A., San Francisco, CA (US)

(72) Inventors: Suresh Reddy, Hyderabad (IN); Rameshchandra Bhaskar Ketharaju, Hyderabad (IN)

(21) Appl. No.: 19/040,588

(22) Filed: Jan. 29, 2025

(51) Int. Cl. G06F 9/48; G06F 9/38; G06F 9/50

(52) U.S. Cl. CPC G06F 9/4881; G06F 9/3836; G06F 9/5027

(57) ABSTRACT

Systems, apparatuses, methods, and computer program products are disclosed for dynamic access restrictions for batch processes. An example method includes receiving conditions for executing a batch process and generating a dynamic access schedule. The example method further includes modifying access permissions of batch process and causing the start of the execution of the batch process in its specific timeframe. The example method further includes adapting the dynamic access schedule based on potential changes in batch process processing. Finally, the example method further includes the revoking of access permission.

### BACKGROUND

Large scale computing task are often completed as a series of batch processes, which may be scheduled ahead of time and require minimal human interaction to complete repetitive tasks. Batch processes may be scheduled to run at off-peak times, when computational resources are commonly more readily available. Batch processes may run sequentially or simultaneously based on the requirements of the batch process.

### BRIEF SUMMARY

A variety of industries rely on the use of batch processes to conduct computationally intensive processes, including but not limited to, financial services, medical research, media production, and the like. As such the batch processes may require access to sensitive and/or restricted data. The batch processes may be scheduled on a consistent basis, allowing the batch processes to occur at a regular time on a recurring basis reducing the required user interactions with batch processes. Consistently scheduled batch processes may be convenient to know when the data needs to be completed to be included in the schedule batch process, and to know when the system may be conducting computationally intensive work.

Traditionally, consistently scheduled batch processes offer a potential security weakness. Knowledge of the batch process schedule may be a security vulnerability that a potential attacker may exploit. For example, a batch process that may receive access to restricted data during its processing occurs at the same time each day, the attacker may target this batch process in an attempt to gain access to the restricted data. A randomized schedule would alleviate some of the security concerns, however, traditionally it has been difficult to produce random schedules for a large number of batch processes, especially if batch processes may rely on the output of other batch processes or other factors to determine when to run. The production of randomized schedules would also require regular user interaction with the batch processes to ensure the batch processes are scheduled appropriately, but traditionally, lower user engagement has been a benefit of using batch processes. Additionally, batch processes being run on a strict schedule may encounter issues if a particular batch process takes longer than expected, as this may disrupt the rest of the scheduled batch processes.

In contrast to these conventional techniques for batch process scheduling, the example embodiments herein describe a system for generating a random dynamic batch process schedule that incorporates all the computational and security requirements for the completion of the process. The scheduling of batch processes is randomized, and security access is only granted to the batch process during the scheduled timeframe for the process. The progress of the batch processes may be monitored, and the schedule adapted if delays in processing occurs. The security access provided to the batch process may be automatically removed upon the conclusion of the batch process and/or the planned termination at the end of the scheduled timeframe.

Accordingly, the present disclosure sets forth systems, methods and apparatuses that achieve a random dynamic batch process schedule. There are many advantages of these, and other embodiments described herein. For instance, the random dynamic schedule may incorporate a variety of information regarding the specific requirements for each batch process. In addition, the random dynamic batch process may allow for the scheduled timeframes for the batch processes to be adapted to ensure completion of the batch process, and subsequently alter the remaining schedule for the remaining batch processes, to ensure their completion. In addition, this adaptation process may require reduced user interaction, compared to other scheduling methods, to ensure the successful completion of the delayed batch process. Additionally, by dynamically providing and revoking security access to sensitive data, the security risk may be reduced. Through providing security access only to the batch processes that require it, and at the time they need it, decreasing the time that batch processes may have security access and reducing the security risk. Conforming to the principle of least privilege, that entities should be granted access only to specific resources that are required to complete specific tasks.

The foregoing brief summary is provided merely for purposes of summarizing some example embodiments described herein. Because the described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a schematic block diagram for the dynamic access restrictions for batch processes in accordance with various example embodiments described herein.

FIG. 2 illustrates a schematic block diagram of example circuitry embodying a system device that may perform various operations in accordance with some example embodiments described herein.

FIG. 3 illustrates a schematic block diagram of example circuitry embodying the dynamic access restriction system that may perform various operations in accordance with some example embodiments described herein.

FIG. 4 illustrates an example flowchart for the dynamic access restriction system, in accordance with some example embodiments described herein.

FIG. 5 illustrates an example flowchart for the use of artificial intelligence models, in accordance with some example embodiments described herein.

FIG. 6 illustrates an example flowchart for the timetable generator circuitry, in accordance with some example embodiments described herein.

FIG. 7 illustrates an example flowchart for the batch processing activator circuitry, in accordance with some example embodiments described herein.

FIG. 8 illustrates an example flowchart for the artificial intelligence model circuitry, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “artificial intelligence model” refers to a program that has been trained on datasets to recognize certain patterns, in the datasets, and apply these patterns to new data and make decisions. Artificial intelligence models may implement different algorithms to apply the information contained within the datasets to new data and make decisions based on the desired implementation of the model. For example, language models (LM) are a type of artificial intelligence model that has been trained on a large amount of text data, and may be implemented to produce text output based on a prompt and input data.

### System Architecture

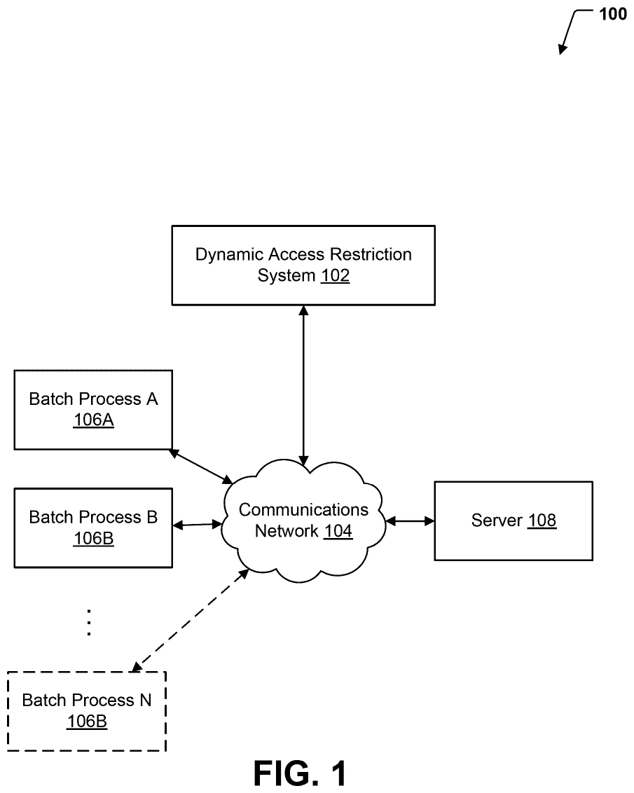

Example embodiments described herein may be implemented using any of a variety of computing devices or servers. To this end, FIG. 1 illustrates an example environment 100 within which various embodiments may operate. As illustrated, a dynamic access restriction system 102 may receive and/or transmit information via communications network 104 (e.g., the Internet) with any number of other devices, such as computing devices running one or more of the batch process A 106A, batch process B 106B through batch process N 106N. Each of the dynamic access restriction system 102 and the batch process A 106A, through batch process N 106N may communicate, via communications network 104, with a connected server 108.

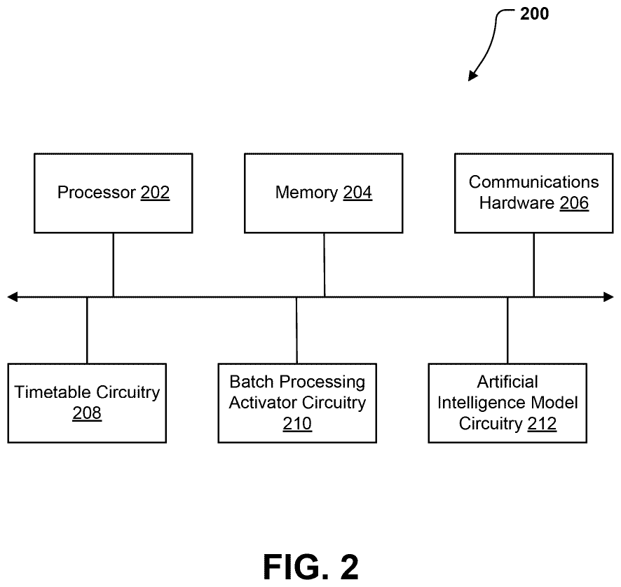

The dynamic access restriction system 102 may be implemented as one or more computing devices or servers, which may be composed of a series of components. Particular components of the dynamic access restriction system are described in greater detail below with reference to apparatus 200 in connection with FIG. 2.

In some embodiments, the dynamic access restriction system 102 may be implemented on one or more computing devices, for example a computer, a mobile device, and/or a server. The one or more batch processes (106A, 106B, . . . , and 106N) may be implemented on one or more computing devices, including but not limited to the computing device running the dynamic access restriction system 102. In various embodiments, in which there are several different computing devices running batch processes (106A, 106B, . . . , and 106N) and the dynamic access restriction system 102, the computing devices may communicate through the communications network 104.

### Example Implementing Apparatuses

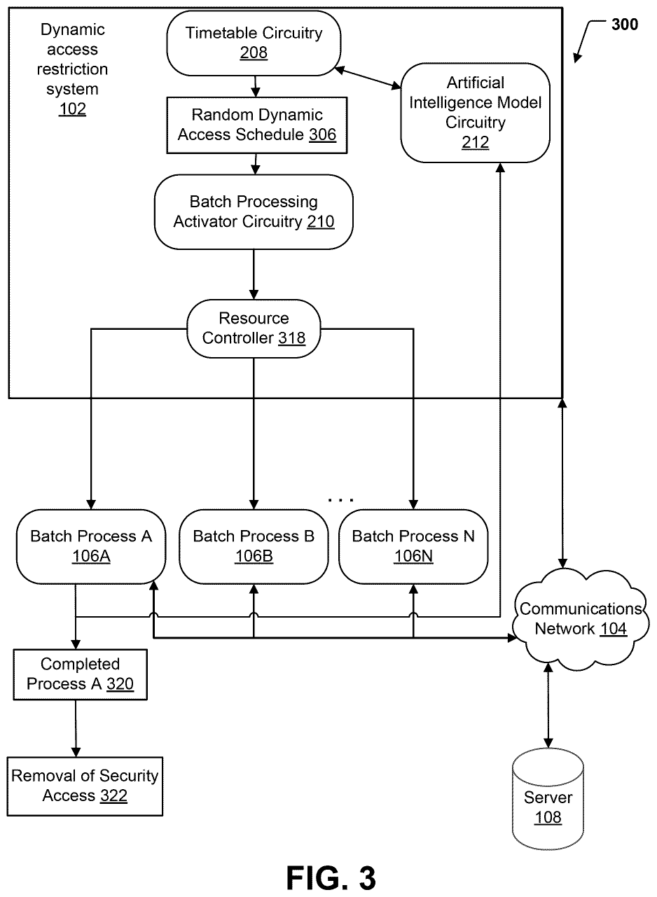

The dynamic access restriction system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-5. As illustrated in FIG. 2, the apparatus 200 may include processor 202, memory 204, communications hardware 206, timetable circuitry 208, batch processing activator circuitry 210, and an artificial intelligence model circuitry 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a timetable circuitry 208 that generates a random dynamic access schedule for batch processes. The timetable circuitry 208 may utilize processor 202, memory 204, or any other hardware component included in the apparatus 200 to perform these operations, as described in connection with FIGS. 3-8 below. The timetable circuitry 208 may further utilize communications hardware 206 to gather data from a variety of sources (e.g., artificial intelligence model circuitry 212, and/or server 108 as shown in FIG. 1, etc.). The timetable circuitry 208 may utilize data produced by the artificial intelligence model circuitry 212 to inform the production of the random dynamic access schedule.

In addition, the apparatus 200 further comprises a batch processing activator circuitry 210 that initiates the batch processes in the specified timeframe allocated by the random dynamic access schedule produced by the timetable circuitry 208. The batch processing activator circuitry 210 may utilize processor 202, memory 204, or any other hardware component included in the apparatus 200 to perform this operation, as described in connection with FIGS. 3-8 below. The batch processing activator may receive the random dynamic access schedule produced by the timetable circuitry 208. The batch processing activator circuitry 210 may further utilize communications hardware 206 to gather data from a variety of sources (e.g., timetable circuitry 208, and/or a server 108 as shown in FIG. 1) and to communicate with batch processes (106A, 106B, . . . , 106N) to initiate the processes in required timeframe.

Further, the apparatus 200 comprises an artificial intelligence model circuitry 212 that can provide information for the timetable circuitry 208 based on previous iterations of the timetable and the potential differences in processing time for the current batch processes, that may be caused by the amount of data requiring processing. The artificial intelligence model may also provide updated information on the progress of the batch processes in their timeframe and whether the produced timetable needs to be altered to ensure the batch process may be allowed to conclude before having its security access terminated and other computing resources reallocated to the next batch process. The artificial intelligence model may utilize processor 202, memory 204, or any other hardware components included in the apparatus 200 to perform these operations, as described in connection with FIGS. 3-8 below. The artificial intelligence model circuitry 212 may be initialized on a remote computing device and/or on a local computing device, and/or any combination thereof. The artificial intelligence model may communicate, via communications network 104 and communications hardware 206, with server 108. In some embodiments, server 108 may contain training datasets required for the training of the artificial intelligence model circuitry 212. The artificial intelligence model circuitry 212 may further utilize communications hardware 206 to gather data from a variety of sources (e.g., the progress of batch processes (106A, 106B, . . . , and 106N) and to communicate to the timetable circuitry 208 and batch processing activator circuitry 210 or any other hardware components included in the apparatus 200 to perform these described operations, as described in further detail below.

Although components 202-212 are described in part using functional language, it will be understood that the particular implementations necessarily include the use of particular hardware. It should also be understood that certain of these components 202-212 may include similar or common hardware. For example, the timetable circuitry 208, batch processing activator circuitry 210, and artificial intelligence model circuitry 212 may each at times leverage use of the processor 202, memory 204, or communications hardware 206, such that duplicate hardware is not required to facilitate operation of these physical elements of the apparatus 200 (although dedicated hardware elements may be sed for any of these components in some embodiments, such as those in which enhanced parallelism may be desired). Use of the term “circuitry” with respect to elements if the apparatus therefore shall be interpreted as necessarily including particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the timetable circuitry 208, batch processing activator circuitry 210, and artificial intelligence model circuitry 212 may leverage processor 202, memory 204, or communications hardware 206, as described above, it will be understood that any of the timetable circuitry 208, batch processing activator circuitry 210, and artificial intelligence model circuitry 212 may include one or more dedicated processor, specifically configured field programmable gate array (FGPA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the timetable circuitry 208, batch processing activator circuitry 210, and artificial intelligence model circuitry 212 comprise particular machinery designed for performing functions described herein in connection with such elements of apparatus 200.

In some embodiments, various components of the apparatuses 200 may be hosted remotely (e.g., by one or more cloud servers) and thus need not physically reside on the corresponding apparatus 200. For instance, some components of the apparatus may not be physically proximate to the other components of apparatus 200. For example, the artificial intelligence model circuitry 212 may access one or more third party circuitry in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

As illustrated in FIG. 3, an example system 300 is shown that represents an example embodiment of the dynamic access restriction system 102, the environments in which it operates, and various processes that may be executed. The dynamic access restriction system 102 may run on a variety of computing devices, for example, a computer and/or a server. The example system 300 may include dynamic access restriction system 102 as pictured, which in turn may include processor 202, memory 204, communications hardware 206 and the like for the implementation of the dynamic access restriction system 102, and these components are excluded from FIG. 3 for clarity (although their functionality may be included, for example, resource controller 318 or other systems depicted in FIG. 3). The example system 300 may include the dynamic access restriction system 102 as shown, which may in turn include processing circuitry, for example, the timetable circuitry 208, the batch processing activator circuitry 210, and the artificial intelligence model circuitry 212 each of which may be configured to function the same as the named components described above in connection with FIG. 2.

In various embodiments, the timetable circuitry 208 may produce a random dynamic access schedule for batch processes (106A, 106B, . . . , and 106N), while taking into account specific requirements for each batch process, including but not limited to; the urgency of the batch process, the processing requirements of the batch process, the potential downtime for clients, the data required for the batch process, and the required security access the batch process requires. The random dynamic access schedule 306 produced by the timetable circuitry 208 may contain timeframes for each batch process (106A, 106B, . . . , and 106N) that are required to run during the time period the random dynamic access schedule 306 covers. For example, if batch process B 106B is only required to run once a week and the time period of the random dynamic access schedule 306 is for 24 hours, batch process B may not be included in the random dynamic access schedule 306. The timetable circuitry 208 may initially take into account information regarding the projected compute time for each batch process, produced by the artificial intelligence model circuitry 212. Subsequently the timetable circuitry 208 may update the random dynamic access schedule 306 based on the projected compute time for the ongoing batch processes, provided by the artificial intelligence model circuitry 212. The random dynamic access schedule 306 and timeframe information may be transmitted to the batch processes (106A, 106B, . . . , and 106N), via the communications network 104. In various examples, the random dynamic access schedule 306 may allow for the overlapping of batch processes that are not constrained by, for example, computation or memory requirements and as such would be able to be processed at the same time without disruption to any of the processes.

In some embodiments, the batch processing activator circuitry 210 may begin the execution of batch processes in their specified timeframe via the communications network 104. The batch processing activator circuitry may, through the resource controller 318, provide the required resources for the batch process to execute during the specified timeframe. For example, the required security access to allow the batch process access to the required data that may be contained on an external server (e.g., server 118) and/or the computational resources required for the batch process to execute (e.g., working memory, central processing unit cores/threads, etc.) may be provided via resource controller 318. In some embodiments, the batch processing activator circuitry 210, may also provide the batch process with a prompt, or the like, to start processing at the beginning of the batch processes timeframe. The batch processor circuitry may also remove the resources from batch processes, either when the batch process successfully completes and/or the planned termination at the end of the timeframe. For example, when batch process A 106A is completed 320, the resource controller 318 may remove the security access 322 and other resources (e.g., memory and computational resources) that may have been provided to the batch process A 106A and provide these resources or similar resources to the next scheduled batch process (e.g., batch process B 106B).

In some embodiments, the artificial intelligence model circuitry 212 may be configured, through the use of training datasets, to estimate the time that each batch process may require to complete its task. The projected processing time may be produced through the analysis of a variety of factors including, but not limited to, the amount of data required to be processed, the computational time required for each step in the task, etc. In some embodiments, the projected processing time, produced by the artificial intelligence model circuitry 212, may be communicated to the timetable circuitry 208 and may improve the produced random dynamic access schedule 306. The artificial intelligence model circuitry 212 may also be configured to track batch process progress. In various embodiments, the artificial intelligence model may be trained on data, such as the processing time required for the various steps in a batch process, the time scaling of processes based on the amount of data processing required, and the like. In some embodiments, the artificial intelligence model circuitry 212 may check the progress of batch processes at various stages and project the time remaining for the completion of batch processes, leveraging information gained through the training data. For example, if batch process A 106A encountered a delay in its first processing step and may not be able to complete in the prescribed timeframe of the random dynamic access schedule 306, the artificial intelligence model circuitry 212 may detect the delay and provide information relating to the delay and a new projected completion time to the timetable circuitry 208. The provided information may allow for the adaptation of the timeframes in the remaining random dynamic access schedule 306 to ensure that batch process A 106A can complete before the removal of the resources, security access, and the beginning of the next batch process (e.g., batch process B 1060B).

Having described specific components of example apparatuses 200 and an example system 300, example embodiments are described below in connection with a series of flowcharts.

### Example Operations

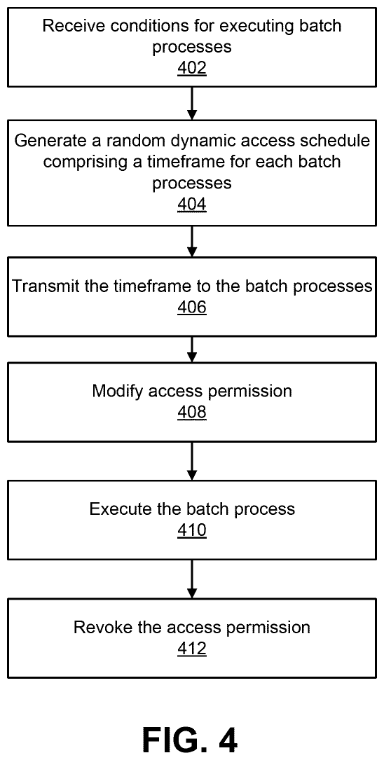

Turning to FIGS. 4-8 example flowcharts are illustrated that contain example operations implemented by example embodiments described herein. The operations illustrated in FIGS. 4-8 may be performed by a computing device (e.g., a computer, a mobile device, and/or a server), connected to a communications network 104 as shown in FIG. 1, which may in turn be embodied by an apparatus 200, which is shown and described in connection with FIG. 2. To perform the operations described below, the apparatus 200 may utilize one or more of processor 202, memory 204, communications hardware 206, timetable circuitry 208, batch processing activator circuitry 210, artificial intelligence model circuitry 212, and/or any combination thereof. It will be understood that user interaction with the dynamic access restriction system 102 may occur directly via communications hardware 206.

As shown by operation 402, the apparatus 200 includes means, such as processor 202, memory 204, communications hardware 206, timetable circuitry 208, artificial intelligence model circuitry 212, or the like, for receiving a condition for executing batch processes. In various embodiments, the communications hardware 206 may receive the conditions from each associated batch process (106A, 106B, . . . , 106N). The information received by the communications hardware 206 may be communicated to the timetable circuitry 208. The timetable circuitry 208 may determine which batch processes need to be scheduled. For example, batch process A 106A (FIG. 1) may be required to run daily, whereas batch process B 106B (FIG. 1) may be required to run once a week, the required frequency of batch processes may be communicated to the timetable circuitry 208 and may be incorporated into the random dynamic access schedule 306 (FIG. 3). In some embodiments, the timetable circuitry 208 may determine the requirements for each batch process to successfully run, for example, the computational processing power, the memory requirements, access to the required data and/or database, security access to sensitive data, etc. The computational requirements may be provided to the timetable circuitry 208 by the artificial intelligence model circuitry 212 and the batch processes (106A, 106B, . . . , 106N). In various embodiments, the artificial intelligence model circuitry 212 may observe the volume of data required to be processed by the batch processes (106A, 106B, . . . , 106N) and may determine, based on the training datasets, the projected time, the computational and memory requirements for processing that volume of data. In some embodiments, the artificial intelligence model circuitry 212 may communicate the projected processing time, for each batch process, to the timetable circuitry 208. In another embodiment, batch process A may communicate with timetable circuitry 208, via communications hardware 206, to provide the security access that will be required for the process to occur, for example, access to restricted data contained on a server (e.g., server 108).

As shown by operation 404, the apparatus 200 includes means, such as processor 202, memory 204, communications hardware 206, timetable circuitry 208, or the like, for generating a random dynamic access schedule comprising a timeframe, wherein the timeframe satisfies the condition for executing the batch process. In some embodiments, the timetable circuitry 208 may determine the requirements for each batch process to successfully run, for example, the computational processing power, the memory requirements, access to the required data and/or database, security access to sensitive data, etc. and determine when each batch process (106A, 106B, . . . , 106N) should be scheduled for optimal performance. The requirements may be provided to the timetable circuitry 208 by the artificial intelligence model circuitry 212 and the batch processes (106A, 106B, . . . , 106N) themselves. In various examples, the artificial intelligence model circuitry 212 may observe the volume of data required to be processed by the batch processes (106A, 106B, . . . , and 106N) and may determine, based on the training datasets, the projected time, the computational and memory requirements for processing that data and communicate these aspects to the timetable circuitry 208. In various embodiments the timetable circuitry 208, may incorporate relevant data in the generation of a random dynamic access schedule, that may ensure that all batch processes that are required to run are able to.

As shown by operation 406, the apparatus 200 includes means, such as processor 202, memory 204, communications hardware 206, timetable circuitry 208, batch processing activator circuitry 210, or the like, for transmitting, by the timetable circuitry 208, the timeframe to the batch process. In various embodiments, the random dynamic access schedule may be transmitted, by the communications hardware 206, to the individual batch processes (106A, 106B, . . . , 106N) and the batch processing activator circuitry 210, which may be running locally on the same device as the timetable circuitry 208 and/or on a remote computing device (e.g., server 108).

As shown by operation 408, the apparatus 200 includes means, such as processor 202, memory 204, communications hardware 206, batch processing activator circuitry 210, or the like, for modifying, at the beginning of the timeframe, an access permission allowing execution of the batch process. In some embodiments, the batch processing activator circuitry 210 may provide the required resources and access permissions required for the scheduled batch process. Batch process A 106A, for example, may require access to a restricted server, containing client information. When batch process A 106A is scheduled to begin the batch processing activator circuitry 210 may provide batch process A 106A with the required security credentials to access the restricted server, thus allowing batch process A 106A to initiate processing.

As shown by operation 410, the apparatus 200 includes means, such as processor 202, memory 204, communications hardware 206, batch processing activator circuitry 210, or the like, for causing a start of the execution of the batch process in the timeframe. In various embodiments, the batch processing activator circuitry 210 may allocate the computing and memory resources required to the batch process and may also provide a prompt and/or a signal to the batch process to begin its processing, at the beginning of the scheduled timeframe. In an example, batch process A 106A may be scheduled to begin at 18:00. In the same example, the batch processing activator circuitry 210 at 18:00 may provide the batch process A 106 with security access to a restricted server, containing sensitive data, allocate 128 gb of random access memory (e.g., from memory 204), 164 processing cores (e.g., processor 202), a signaling prompt, and/or any combination thereof to facilitate the start of batch process A 106A.

As shown by operation 412, the apparatus 200 includes means, such as processor 202, memory 204, communications hardware 206, timetable circuitry 208, batch processing activator circuitry 210, artificial intelligence model circuitry 212, or the like, for revoking the access permission. In some embodiments, the batch processing activator circuitry 210, may revoke the access permission from batch processes (106A, 106B, . . . , and 106N) at the conclusion of their scheduled timeframe. The removal of access permission from batch process may not be contingent on the completion of a batch process, but rather may be contingent on the planned termination of the batch process at the end of the scheduled timeframe, with the implementation of the artificial intelligence model circuitry 212 tracking and/or updating the timetable circuitry 208, the timeframe may be adjusted to ensure the process finishes before the removal of access permission. Batch process A 106A, for example, may have encountered delays in processing, the artificial intelligence model circuitry 212 may detect this delay and estimate how long the remaining data will take to process. The artificial intelligence model circuitry 212 may inform the timetable circuitry 208 how long batch process A 106A will take to complete after the delay. The timetable circuitry 208 may adjust the timeframe for batch process A 106A, extending it to ensure completion of the process. The timetable circuitry 208 may adjust the random dynamic access schedule to incorporate the extended timeframe for batch process A 106A. In another example batch process B 106B may have completed before the end of the scheduled timeframe, in this case the artificial intelligence model circuitry 212, may inform the timetable circuitry 208, and the random dynamic access schedule adjusted to reduce the timeframe for batch process B 106B, subsequently ending the timeframe. Allowing batch processing activator circuitry 210 to remove security access permission. In another embodiment, the batch processing activator circuitry 210 may fail to terminate batch process A 106A at the end of its designated timeframe, as the process is still ongoing. The failure of termination may be communicated to timetable circuitry 208, which may modify the timeframe for batch process A 106A. Allowing for batch process A 106A to be restarted and conclude in the modified timeframe, and the revision of the random dynamic access schedule based on the modified timeframe. Upon the completion of batch process A 106A and/or the planned termination at the end of the modified timeframe, the batch processing activator circuitry 210 may terminate batch process A 106A and revoke security access. The ability of the dynamic access restriction system 102 to dynamically revoke the security access permission, based on the early completion of a batch processes, may improve the overall security of the system.

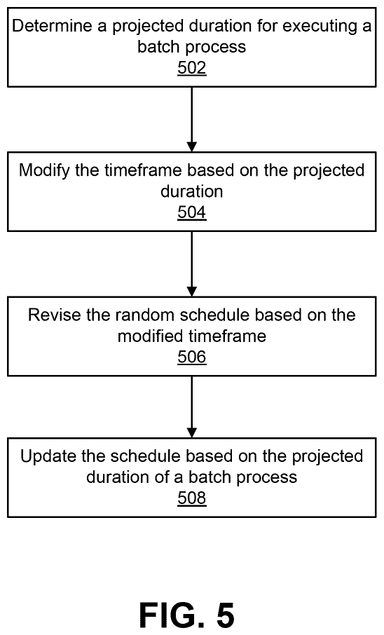

Turning now to FIG. 5, example operations for determining a projected duration for executing a batch process based on the random dynamic access schedule.

As shown by operation 502, the apparatus 200 includes means, such as processor 202, memory 204, communications hardware 206, artificial intelligence model circuitry 212, or the like for determining a projected duration for executing a batch process based on the random dynamic access schedule. In some embodiments, the artificial intelligence model circuitry 212 may analyze the amount of data each batch process is required to process, and determine the computational time required to process, the data based on historical training datasets. For example, batch process A 106A may process 100 transactions, the artificial intelligence model circuitry 212 may determine that 1 hour would be the required time for batch process A 106A to complete. The artificial intelligence model circuitry 212 may project this time based on historical data of batch process A 106A and average processing time per transaction, presented to the artificial intelligence model in training datasets. In some embodiments, the datasets may be continually updated with data based on the outcome of batch processes.

As shown by operation 504, the apparatus 200 includes means, such as processor 202, memory 204, communications hardware 206, timetable circuitry 208, artificial intelligence model circuitry 212, or the like for modifying the timeframe based on the projected duration of a batch process. In some embodiments, the projected duration of a batch process, produced by artificial intelligence model circuitry 212, may be used by the timetable circuitry 208 to inform the required timeframe for a batch process to complete.

As shown in operation 506, the apparatus 200 includes means, such as processor 202, memory 204, communications hardware 206, timetable circuitry 208, batch processing activator circuitry 210, artificial intelligence model circuitry 212, or the like for revising the random dynamic access schedule based on the modified timeframe. In some embodiments, the timetable circuitry 208 may incorporate the new timeframe determined by the artificial intelligence model circuitry 212, in an updated random dynamic access schedule. That may be communicated to the batch processing activator circuitry 210.

As shown in operation 508, the apparatus 200 includes means, such as processor 202, memory 204, communications hardware 206, timetable circuitry 208, batch processing activator circuitry 210, artificial intelligence model circuitry 212, or the like for updating the timetable circuitry 208, based on the projected duration of ongoing batch processes. In some embodiments the artificial intelligence model circuitry 212 may monitor the progress of batch processes. The artificial intelligence model circuitry 212 may provide feedback on the projected completion time of the batch processes to the timetable circuitry 208, to allow revision of the random dynamic access schedule. In some embodiments, the revision of the random dynamic access schedule may take into account the updated projected completion time of the process, potentially extending the timeframe for the batch process in question, preventing the removal of the required security access and allowing the batch process to complete. The updated random dynamic access schedule may be communicated to the batch processing activator circuitry 210, to prevent the termination of the ongoing process and the removal of security access. In some embodiments, the dynamic access restriction system 102, may allow for the adaptation of the random dynamic access schedule, based on the projections from the artificial intelligence model circuitry 212, with user feedback via the communications hardware 206.

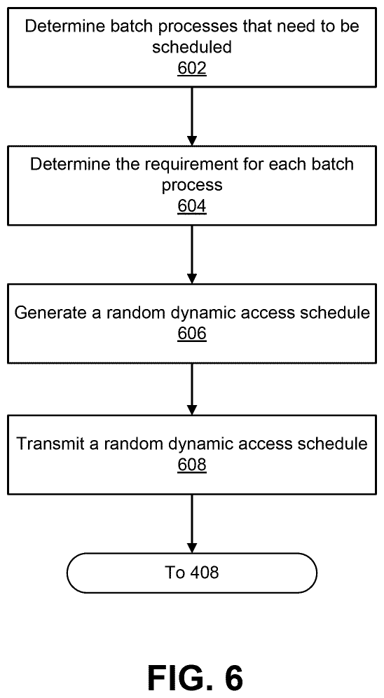

Turning now to FIG. 6, example operations of the timetable circuitry 208 are shown for the generation of a random dynamic access schedule.

As shown in operation 602, the apparatus 200 includes means, such as processor 202, memory 204, communications hardware 206, timetable circuitry 208, artificial intelligence model circuitry 212, or the like for determining batch processes that need to be scheduled. In various embodiments, timetable circuitry 208 may receive data, via the communications hardware 206, regarding the batch processes (106A, 106B, . . . , 106N) that need to be conducted. The data relating to which batch processes need to be conducted may be sent from the individual processes themselves (e.g., batch processes 106A, 106B, . . . , and 106N), from the artificial intelligence model circuitry 212, which may be trained on institutional best practices for the frequency in which certain batch processes must be conducted, from direct user input into the dynamic access restriction system 102, or any combination thereof.

As shown in operation 604, the apparatus 200 includes means, such as processor 202, memory 204, communications hardware 206, timetable circuitry 208, artificial intelligence model circuitry 212, or the like for determining the requirement for each batch process. In various embodiments, the timetable circuitry 208 may determine, based on provided information, a resource requirement for each batch process (e.g., batch processes 106A, 106B, . . . , and 106N) included in the random dynamic access schedule. The resource requirements for each batch process (106A, 106B, . . . , 106N) may be communicated, via communications hardware 206, to the timetable circuitry 208 from the individual batch processes (e.g., batch processes 106A, 106B, . . . , and 106N), from the artificial intelligence model circuitry 212, or any combination thereof. The resource requirements may be the required computational resources required for the completion of the batch process, for example the CPU processing time, the random access memory volume, GPU processing time, etc. The resource requirements may be access to required data, for example sensitive user data stored on servers (e.g., server 108) that the batch process requires access to for the completion of the process.

As shown in operation 606, the apparatus 200 includes means, such as processor 202, memory 204, communications hardware 206, timetable circuitry 208, or the like for generating a random dynamic access schedule. In some embodiments, timetable circuitry 208 as discussed above, may incorporate all data regarding the requirements of the batch processes (106A, 106B, . . . , 106N) to produce a random dynamic access schedule, that will provide timeframes for each batch process. The random dynamic access schedule generated by the timetable circuitry 208 may use the requirements and estimated processing time to ensure the required batch processes complete in their required timeframe.

As shown in operation 608, the apparatus 200 includes means, such as processor 202, memory 204, communications hardware 206, timetable circuitry 208, or the like for transmitting the random dynamic access schedule. In various embodiments, the random dynamic access schedule may be transmitted, by the communications hardware 206, to the individual batch processes (106A, 106B, . . . , 106N) and the batch processing activator circuitry 210, which may be running locally on the same device as the timetable circuitry 208 and/or on a remote computing device (e.g., server 108).

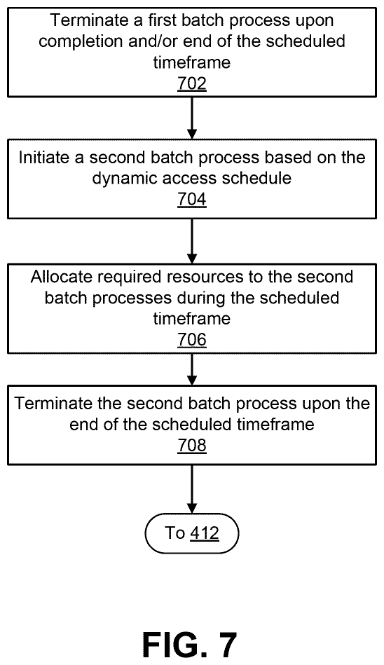

Turning now to FIG. 7, example operations of the batch processing activator circuitry 210.

As shown in operation 702, the apparatus 200 includes means, such as processor 202, memory 204, communications hardware 206, timetable circuitry 208, batch processing activator circuitry 210, or the like for terminating a first batch process upon completion and/or at the planned termination at the end of the scheduled timeframe as dictated by the random dynamic access schedule produced by the timetable circuitry 208. In various embodiments, the batch processing activator circuitry 210 may terminate a batch process (e.g., batch processes 106A, 106B, . . . , and 106N) upon the completion of the batch process and/or at the end of the scheduled timeframe for the batch process, communicated to the batch processing activator circuitry 210 by the timetable circuitry 208. When terminating a batch process, the batch processing activator circuitry 210 may remove computing resources and/or security access from the batch process.

As shown in operation 704, the apparatus 200 includes means, such as processor 202, memory 204, communications hardware 206, timetable circuitry 208, batch processing activator circuitry 210, or the like for initiating a second batch process based on the random dynamic access schedule. In various embodiments, the batch processing activator circuitry 210 may initiate a second batch process after the termination of a first batch process.

As shown in operation 706, the apparatus 200 includes means, such as processor 202, memory 204, communications hardware 206, batch processing activator circuitry 210, or the like for allocating required resources to the second batch process during the scheduled timeframe. In some embodiments, batch processing activator circuitry 210 may allocate and/or provide the resources to the scheduled batch process (e.g., batch processes 106A, 106B, . . . , and 106N). Batch process B 106B, for example, may require computational power and access to a restricted server, containing client information. Batch process A 106A, for example, may be conducted in the previous timeframe and may be using computational power and security access, at the conclusion of bath process A 106A the batch process activator circuitry 210 may terminate batch process A 106A and/or may re-allocate the security access and the computational power to batch process 106B, thus allowing batch process B 106B to initiate processing.

As shown in operation 708, the apparatus 200 includes means, such as processor 202, memory 204, communications hardware 206, batch processing activator circuitry 210, or the like for terminating the second batch process upon the end of the scheduled timeframe. In various embodiments, batch processing activator circuitry 210 may terminate a batch process (e.g., batch processes 106A, 106B, . . . , and 106N) at the end of the scheduled timeframe. For example, batch process A 106A may have a scheduled timeframe of 10:00-12:00 in the random dynamic access schedule. At 12:00 the batch processing activator circuitry 210 may terminate batch process A 106A and remove the associated allocated resources, in preparation for the next batch process if there is one scheduled after batch process 106A. In some embodiments, the batch processing activator circuitry 210 may also terminate the second batch process upon the completion of the second batch process within the timeframe. For example, if batch process B 106B was scheduled to run from 12:00-15:00. Batch process B 106B successfully completes at 14:55, the batch processing activator circuitry 210 may terminate batch process B 106 and remove the associated required resources.

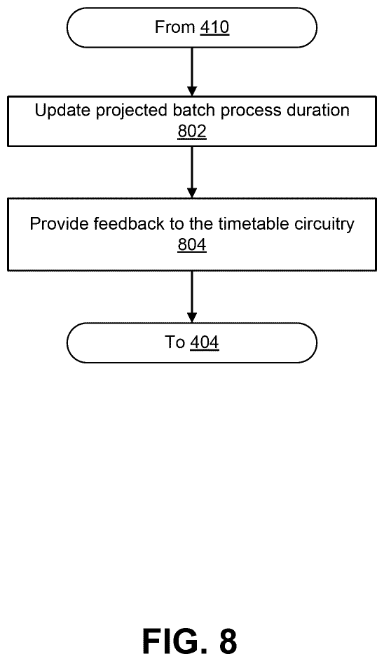

Turning now to FIG. 8, an example implementation of the artificial intelligence model circuitry 212 for the updating of the random dynamic access schedule by the timetable circuitry 208.

As shown in operation 802, the apparatus 200 includes means, such as processor 202, memory 204, communications hardware 206, artificial intelligence model circuitry 212, or the like for updating projected batch process duration. In various embodiments, the artificial intelligence model circuitry 212 may analyze the remaining data for the ongoing batch process (e.g., batch processes 106A, 106B, . . . , and 106N) and update the projected batch process duration, based on historical training data. The updated batch process duration may be communicated to the timetable circuitry 208. For example, batch process 106A may be delayed in processing data, the artificial intelligence model circuitry 212 may update the estimated processing time based on the remaining data, the estimated processing time is now past the planned termination at the end of the scheduled timeframe for batch process 106A, this is communicated to the timetable circuitry 208. In another example, batch process 106B is processing data quicker than initially predicted, as such there is less data remaining for processing, the artificial intelligence model circuitry 212 may update the projected batch process duration to be shorter, this is communicated to the timetable circuitry 208. As shown in FIG. 8, updating the projected batch process duration may occur after (or in parallel with) executing the bath processes (e.g., as shown in operation 410).

As shown in operation 804, the apparatus 200 includes means, such as processor 202, memory 204, communications hardware 206, timetable circuitry 208, artificial intelligence model circuitry 212, or the like for providing feedback to the timetable circuitry. In various embodiments the artificial intelligence model circuitry 212 may communicate updated projected batch process duration, via the communications hardware 206, to the timetable circuitry 208. This will allow for changes in the predicted processing times of the batch processes (106A, 106B, . . . , and 106N) to be continually updated to the timetable circuitry 208. The timetable circuitry 208 may incorporate the updated batch process duration in subsequent versions of the random dynamic access schedule. New versions of the random dynamic access schedule may be produced by the timetable circuitry 208 when timeframes may have to be altered to ensure the completion of the ongoing batch process (e.g., as shown in operation 404 when generating a random dynamic access schedule).

FIGS. 4-8 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations described above in connection with FIGS. 4-8 may be modified or further amplified. Furthermore, in some embodiments, additional optional operations may be included. Modifications, amplifications, or additions to the operations above may be performed in any order and in any combination.

### CONCLUSION

As described above, example embodiments provide methods and apparatuses that enable improved dynamic access restrictions for batch processes. Example embodiments thus provide tools that overcome the problems faced by scheduling batch processes, example embodiments automatically schedule batch processes, taking into account the various requirements for each batch process. Moreover, embodiments described herein avoid issues relating to delayed or extended batch processes, by automating the timetable generation with use of an artificial intelligence model, the scheduling performed by example embodiments do not require user intervention to proceed with alteration in the random dynamic access schedule.

As these examples all illustrate, example embodiments contemplated herein provide technical solutions that solve real-world problems faced during batch process scheduling. And while batch process scheduling has been conducted for decades, the recent ability of artificial intelligence models to analyze large amount of data and produce outputs based on input data allows for the scheduling to be informed by an artificial intelligence model trained on data relating to the batch processes. The ubiquity of artificial intelligence models has unlocked new avenues for solving the scheduling problems that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the interventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for dynamic access scheduling, the method comprising:
receiving, by communications hardware, a condition for executing a batch process,
generating, by timetable circuitry, a random dynamic access schedule comprising a timeframe, wherein the timeframe satisfies the condition for executing the batch process;
transmitting, by the timetable circuitry, the timeframe to the batch process;
modifying, by batch processing activator circuitry and at a beginning of the timeframe, an access permission allowing execution of the batch process;
causing, by the batch processing activator circuitry, a start of the execution of the batch process in the timeframe; and
at a conclusion of the timeframe, revoking, by the batch processing activator circuitry, the access permission.

2. The method of claim 1, further comprising:
determining, by the batch processing activator circuitry and using an artificial intelligence model, a projected duration for executing the batch process based on the random dynamic access schedule; and
in an instance in which the projected duration indicates that completion of the execution of the batch process occurs after the timeframe:
modifying, by the timetable circuitry, the timeframe based on the projected duration, and
revising, by the timetable circuitry, the random dynamic access schedule based on modifying the timeframe.

3. The method of claim 2, further comprising:
updating, by the artificial intelligence model, the random dynamic access schedule based on the projected duration and the completion of the execution of batch processes,
wherein generating the random dynamic access schedule is further based on an output from the artificial intelligence model.

4. The method of claim 1, further comprising:
determining, by the timetable circuitry and based on the random dynamic access schedule, a resource requirement for the batch process; and
allocating, by the batch processing activator circuitry, a computing resource based on the resource requirement for the batch process.

5. The method of claim 4, wherein allocating the computing resource comprises terminating a second batch process.

6. The method of claim 1, wherein the condition for executing the batch process comprises a successful termination of a second batch process, wherein satisfying the condition for executing the batch process comprises ordering the timeframe after a planned termination of the second batch process, wherein the method further comprises:
receiving, by the batch processing activator circuitry, an indication of the successful termination of the second batch process.

7. The method of claim 1, further comprising:
receiving, by the batch processing activator circuitry, an indication of a failed termination of the batch process;
modifying, by the timetable circuitry, the timeframe based on the failed termination of the batch process;
causing, by the batch processing activator circuitry, a restart of the execution of the batch process in the timeframe based on modifying the timeframe; and
revising, by the timetable circuitry, the random dynamic access schedule based on modifying the timeframe.

8. An apparatus for dynamic access scheduling, the apparatus comprising:
communications hardware configured to receive a condition for executing a batch process;
timetable circuitry configured to:
generate a random dynamic access schedule comprising a timeframe, wherein the timeframe satisfies the condition for executing the batch process, and
transmit the timeframe to the batch process; and
batch processing activator circuitry configured to:
modify, at a beginning of the timeframe, an access permission allowing execution of the batch process,
cause a start of the execution of the batch process in the timeframe; and
at a conclusion of the timeframe, revoke the access permission.

9. The apparatus of claim 8, wherein the batch processing activator circuitry is further configured to:
determine, using an artificial intelligence model, a projected duration for executing the batch process based on the random dynamic access schedule,
wherein the timetable circuitry is further configured to:
in an instance in which the projected duration indicates that completion of the execution of the batch process occurs after the timeframe:
modifying the timeframe based on the projected duration, and
revising the random dynamic access schedule based on modifying the timeframe.

10. The apparatus of claim 9, wherein the artificial intelligence model is configured to:
update the random dynamic access schedule based on the projected duration and the completion of the execution of batch processes,
wherein generating the random dynamic access schedule is further based on an output from the artificial intelligence model.

11. The apparatus of claim 8, wherein the timetable circuitry is further configured to:
determine, based on the random dynamic access schedule, a resource requirement for the batch process,
wherein the batch processing activator circuitry is further configured to allocate a computing resource based on the resource requirement for the batch process.

12. The apparatus of claim 11, wherein allocating the computing resource comprises terminating a second batch process.

13. The apparatus of claim 8, wherein the condition for executing the batch process comprises a successful termination of a second batch process, wherein satisfying the condition for executing the batch process comprises ordering the timeframe after a planned termination of the second batch process,
wherein the batch processing activator circuitry is further configured to receive an indication of the successful termination of the second batch process.

14. The apparatus of claim 8,
wherein the batch processing activator circuitry is further configured to receive an indication of a failed termination of the batch process,
wherein the timetable circuitry is further configured to modify the timeframe based on the failed termination of the batch process,
wherein the batch processing activator circuitry is further configured to cause a restart of the execution of the batch process in the timeframe based on modifying the timeframe, and
wherein the timetable circuitry is further configured to revise the random dynamic access schedule based on the modifying the timeframe.

15. A computer program product for dynamic access scheduling, the computer program product comprising at least one non-transitory computer-readable storage medium storing program instructions that, when executed, cause a system to:
receive a condition for executing a batch process,
generate a random dynamic access schedule comprising a timeframe, wherein the timeframe satisfies the condition for executing the batch process;
transmit the timeframe to the batch process;
modify, at a beginning of the timeframe, an access permission allowing execution of the batch process;
cause a start of the execution of the batch process in the timeframe; and
at a conclusion of the timeframe, revoke the access permission.

16. The computer program product of claim 15, further comprising additional program instructions that, when executed, cause the system to:
determine, using an artificial intelligence model, a projected duration for executing the batch process based on the random dynamic access schedule; and
in an instance in which the projected duration indicates that completion of the execution of the batch process occurs after the timeframe:
modify the timeframe based on the projected duration, and
revise the random dynamic access schedule based on modifying the timeframe.

17. The computer program product of claim 16, further comprising additional program instructions that, when executed, cause the system to:
update the random dynamic access schedule based on the projected duration and the completion of the execution of batch processes,
wherein generating the random dynamic access schedule is further based on an output from the artificial intelligence model.

18. The computer program product of claim 15, further comprising additional program instructions that, when executed, cause the system to:
determine, based on the random dynamic access schedule, a resource requirement for the batch process; and
allocate a computing resource based on the resource requirement for the batch process.

19. The computer program product of claim 18, wherein allocating the computing resource comprises terminating a second batch process.

20. The computer program product of claim 15, wherein the condition for executing the batch process comprises a successful termination of a second batch process, wherein satisfying the condition for executing the batch process comprises ordering the timeframe after a planned termination of the second batch process, wherein the computer program product further comprising additional program instructions that, when executed, cause the system to:
receive an indication of the successful termination of the second batch process.
